(19) United States
(12) Patent Application Publication
(10) Pub. No.: US 2017/0025048 A1
(43) Pub. Date: Jan. 26, 2017

(54) ORNAMENTAL CHARACTERS WITH A LIGHT STRING HOLDING CHANNEL AND SIGNAGE FORMED THEREFROM

(71) Applicant: PTC International, Baltimore, MD (US)

(72) Inventor: Michael LEE, Baltimore, MD (US)

(21) Appl. No.: 14/808,652

(22) Filed: Jul. 24, 2015

(51) Int. Cl. G09F 13/04

(52) U.S. Cl. CPC G09F 13/0404

(57) ABSTRACT

An ornamental character element includes a channel including at least one wall defining an open end configured to form a character shape. An opening is provided in the at least one wall and is dimensioned for passage of a light string into or out of the channel. A plurality of retention elements are disposed adjacent the open end of the channel and configured to intermittently block the open end of the channel along a length thereof to allow retention of the light string. An ornamental sign can include a first character element comprising a first connection member extending therefrom, and a second character element comprising a second connection member extending therefrom and configured to interface and connect to the first connection.

### BACKGROUND

Field

The present invention relates to ornamental characters and signage, and more particularly to ornamental characters and signage adapted to be illuminated with a string of lights.

Discussion of the Background

Ornamental signage, such as displays with messages such as “Happy Birthday,” “Merry Christmas,” “Congratulations,” etc., or decorative items such as initials, are popular. However, these items are typically not customizable, especially when they include illumination. Strings of lights (alternately referred to as “light strings”) are also popular for providing decoration, but can be difficult to arrange into messages.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments relate to ornamental characters that include a light string holding channel.

Exemplary embodiments further relate to ornamental signage produced by coupled characters that include a light string holding channel.

Additional aspects will be set forth in the detailed description which follows, and, in part, will be apparent from the disclosure, or may be learned by practice of the inventive concept.

An exemplary embodiment discloses an ornamental character that includes a channel having at least one wall defining an open end configured to form a character shape, an opening in the at least one wall dimensioned for passage of a light string and retention elements disposed adjacent the open end of the channel and configured to intermittently block the open end of the channel along a length thereof to allow retention of the light string.

In an embodiment, the channel comprises a cross section selected from the group consisting of a semi-circle, a parabola, a semi-oval, a V-shape, a U-shape, an open-ended rectangle, an open-ended trapezoid, an open-ended polygon comprising 4 or more walls, and combinations thereof.

In an embodiment, the character shape is selected from the group consisting of a letter, a number, a punctuation mark, a heart, a spade, a diamond, a club, a star, a musical note, a musical-instrument shape, an arrow, a mathematical symbol, a currency symbol, a leaf, a flower, a bow, an emoticon, a candle, and a religious symbol.

In an embodiment, the channel is made from a transparent or translucent material.

In an embodiment, the channel includes a reflective or light-diffusing material.

In an embodiment, the ornamental character further includes a connection member extending from the at least one wall.

In an embodiment, the opening may take the form of a through-hole or an open-ended slot.

In an embodiment, the retention elements may take the form of straps. The straps may further be transparent straps or translucent straps. The retention elements may also take the form of tabs extending inward from a wall forming the open end.

In an embodiment, the ornamental character may further include hooks extending inward into the channel from the at least one wall.

In an embodiment, the ornamental character may further include the light string at least partially disposed in the channel and having at least one portion passing through the opening, wherein the retention elements are configured to retain the light string within the channel when the channel is oriented vertically.

An exemplary embodiment also discloses an ornamental sign that includes a first character element having a first connection member extending therefrom and a second character element having a second connection member extending therefrom and configured to interface and connect to the first connection. Each of the first character element and the second character element have a channel with at least one wall defining an open end configured to form a character shape, an opening in the at least one wall dimensioned for passage of a light string, and retention elements disposed adjacent the open end of the channel and configured to intermittently block the open end of the channel along a length thereof to allow retention of the light string.

In an embodiment, the channels of the first and second character elements may have a cross section selected from the group consisting of a semi-circle, a parabola, a semi-oval, a V-shape, a U-shape, an open-ended rectangle, an open-ended trapezoid, an open-ended polygon comprising 4 or more walls, and combinations thereof.

In an embodiment, the first and second character element shapes are selected from the group consisting of a letter, a number, a punctuation mark, a heart, a spade, a diamond, a club, a star, a musical note, a musical-instrument shape, an arrow, a mathematical symbol, a currency symbol, a leaf, a flower, a bow, an emoticon, a candle, and a religious symbol.

In an embodiment, the openings in the first and second character elements may take the form of a through-hole or an open-ended slot.

In an embodiment, the first connection member includes a strap having a first side of a fastener, and the second connection member includes a strap having a second complementary side of the fastener. Optionally, the fastener may be selected from the group of buckles, snaps, hook-and-eye fasteners, button-and-hole fasteners, hook-and-loop fasteners, and adhesives.

In an embodiment, the strap of at least one of the first connection member and the second connection member is adjustable in length.

In an embodiment, the openings of the character elements may take the form of a through-hole or an open-ended slot.

In an embodiment, the retention elements of the character elements are selected from the group consisting of straps, transparent straps, translucent straps, and inward-extending tabs.

In an embodiment, the ornamental sign further includes the light string at least partially disposed in the channel of the first character element and includes at least a first portion passing through the opening in the first character element. The light string is also at least partially disposed in the channel of the second character element and includes at least a second portion passing through the opening in the second character element. The retention elements are configured to retain the light string within the channels when the channels of the first and second character elements are oriented vertically.

In an embodiment, the channels of the character elements include a transparent or translucent material.

In an embodiment, the channels of the character elements include a reflective or light-diffusing material.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a plan view of an ornamental character according to an exemplary embodiment.

FIG. 2 is a cross section of an ornamental character according to an exemplary embodiment.

FIGS. 3A, 3B, 3C, 3D, 3E, and 3F are alternate cross sectional shapes of an ornamental character according to exemplary embodiments.

FIGS. 4A and 4B are plan views of an ornamental character according to another exemplary embodiment.

FIG. 5 is a cross section of an ornamental character according to another exemplary embodiment.

FIGS. 6A and 6B are plan views of ornamental signs according to exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of elements, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. As such, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

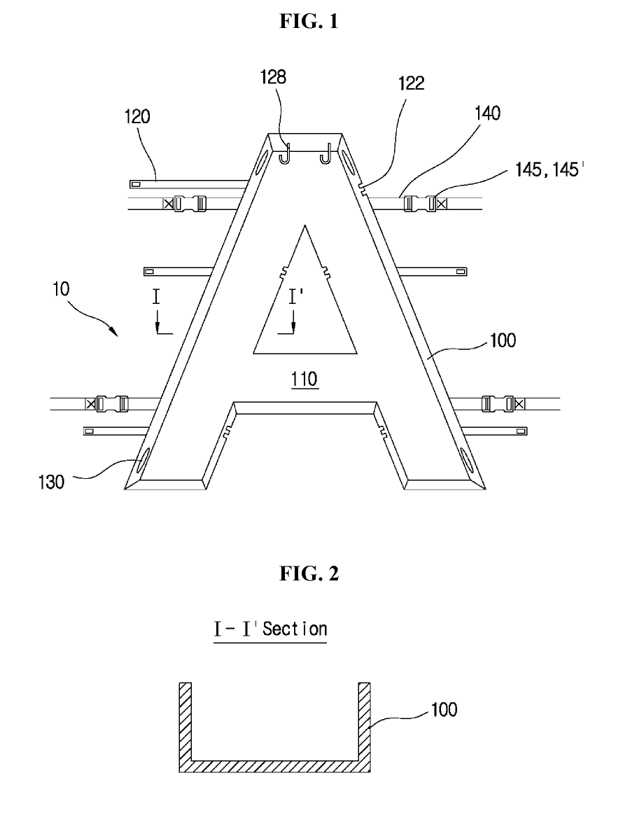

FIG. 1 illustrates a plan view of an ornamental character according to an exemplary embodiment, and FIG. 2 is a cross section of an ornamental character according to an exemplary embodiment. In FIG. 1, an ornamental character 10 (also referred to a character or character element) is shown in an exemplary embodiment of a capital letter “A.” Although described herein with respect to the letter “A” in a Latin alphabet, the character 10 may take many forms, including but not limited to lower-case letters, other letters of other alphabets such as Greek, Cyrillic, Hebrew, Japanese, Korean, Chinese or Arabic alphabets, numbers, punctuation marks, mathematical symbols, currency symbols, and symbols or shapes such as emoticons, hearts, spades, diamonds, clubs, stars, musical notes, musical-instrument shapes, arrows, leaves, flowers, bows, candles, and religious symbols, such as a Star of David, a crescent, or a cross.

The character 10 includes a wall or walls 100 that form a channel or channels 110 which have an open top portion (i.e., an opening). The channel(s) 110 are arranged to form the outline of the character 10 and the walls 100 forming the channels 110 create a concavity dimensioned to hold portions of a light string. To retain the light string (not shown) in the channel 110, a plurality of retention members such as bands or straps 120 may be provided adjacent the open end of the channel and configured to intermittently block the open end of the channel along a length thereof.

The walls 100 may be formed from any suitable material, such as a plastic or metal. If formed using an opaque material, it is preferable to provide a highly reflective surface to an inside surface of the wall or walls 100 forming the channel 110. If the reflective surface is additionally textured so as to highly diffuse the light, the illuminated characters can have improved visibility. However, embodiments are not limited to such reflective or diffusing surfaces, and may also include light absorbing or partially light absorbing surfaces. The surface can additionally provide a color if desired. In this manner, the light from a light string (not shown) will radiate from the open top of the opaque channel 110. If formed from a transparent or translucent material, the light from a light string (not shown) may radiate through the walls in addition to from the open top of the channel 110. In this embodiment, reflective or light-diffusing material may be coated on or dispersed within the transparent/translucent walls 100 to improve visibility of the character 10. However, embodiments are not limited to such reflective or diffusing materials, and may also include light absorbing or partially light absorbing materials.

Although the characters 10 may be made in any of various sizes, an exemplary embodiment may provide characters 10 of approximately 12 inches tall with a channel width and depth of approximately 2 inches so as to provide a sufficient volume for retaining multiple individual lights of a light string (not shown), as well as good visibility of the character at distance.

In the exemplary embodiment illustrated in FIG. 1, the straps 120 are in the form of a clear silicone band that is attached to the top of wall 100 at one end and comprises a hole at the free end. The band can be stretched across the open end of channel 110, and the hole in the free end of the band can engage a “nub” or notch 122 positioned on the top of the wall 110 on an opposite side of the channel. When the strap 120 is engaged in this manner, the light string (not shown) may be retained in the channel 110 even when the channel 110 is oriented vertically. Although disclosed as a clear silicone band, the strap may be made from other materials without departing from the exemplary embodiments. However, in order to allow light from light strings (not shown) to remain visible, the straps 120 should preferably be made either thin and/or of transparent/translucent material so as to not block light.

In addition to (or in place of) straps 120, the character 10 may include hooks 128 extending inward from walls 100 into the channel 110. While preferably located at terminal portions of the character 10 so as to retain the light string (not shown) in all portion of the channels 110, it is also possible to position the hooks 128 at other locations along the channels 110 in addition to or in place of other retention members such as straps 120 for the purpose of retaining the light string (not shown) within the channels 110.

The character 10 may also include one or more openings 130 in the walls 100 for the entry and/or exit of a light string (not shown) from the channels 110. In the exemplary embodiment of FIG. 1, the character 10 includes four (4) openings 130 in the form of a pair in the bottom side walls and a pair in the upper side walls of the channels 110, but embodiments are not limited thereto. Moreover, although disclosed as through-holes, the openings 130 are adjacent an edge, and thus may also take the form of a slot and still provide passage of the light string (not shown) into or out of the channel 110.

The character 10 may further include one or more connection members for supporting the character 10 relative to a support. While disclosed as straps 140 with buckles 145, 145′ extending from the sides of the characters 10, connection members may take many other forms without departing from exemplary embodiments. For instance, for hanging on a wall, ceiling, gutter, or overhang, a connection member may take the form of a wire hanger, a hook, or an adhesive (such as a 3M Command™ adhesive) extending from a top or back surface of the character 10. In the illustrated embodiment of FIG. 1, the connection members include straps 140 connected to the side walls 100. The straps 140 have male and female buckle elements 145, 145′ for interconnecting to other similar characters 10. By providing straps 140 with male buckles 145 on one side and straps 140 with female buckle elements 145′ on the other side, adjacent characters 10 can be connected to form signs (signage).

The length of the straps 140 may be adjustable relative to the buckle elements 145, 145′. However, if not adjustable, the length of the straps 140 can be standardized to extend a predetermined distance horizontally relative to the widest point of the character 10. In this manner, adjacent characters may appear equally spaced from each other (e.g., for kerning of proportional fonts). The straps 140 may also be provided to be removable from the character 10. In this manner, when a character 10 does not have another character adjacent thereto or when alternate supports are provided, the unneeded strap 140 can be removed for aesthetic purposes.

FIG. 2 illustrates a channel 110 formed with walls 100 and having an open-topped rectangular cross section. However, embodiments of the invention are not limited to such cross sections.

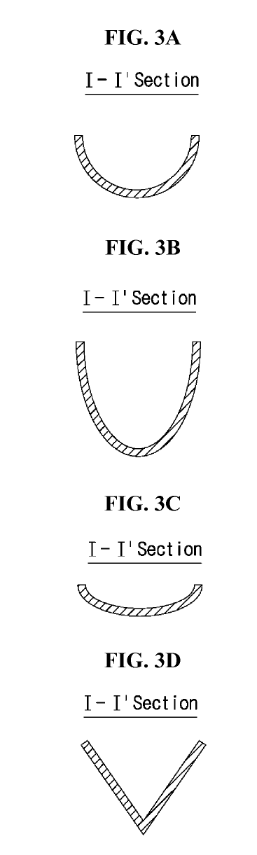

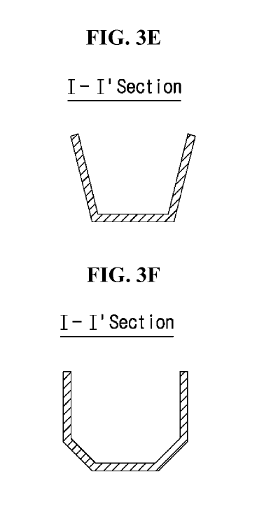

FIGS. 3A, 3B, 3C, 3D, 3E, and 3F are alternate cross sectional shapes of an ornamental character according to exemplary embodiments. FIG. 3A illustrates an embodiment having a substantially semi-circular cross section. FIG. 3B illustrates an embodiment having a substantially parabolic cross section. FIG. 3C illustrates an embodiment having a substantially semi-oval cross section. FIG. 3D illustrates an embodiment having a substantially V-shaped cross section. FIG. 3E illustrates an embodiment having a substantially open-topped trapezoidal cross section. FIG. 3F illustrates an embodiment having a substantially polygonal cross section having more than 4 walls. A common attribute of all of these exemplary embodiments is a concave channel that can hold a light string (not shown) and typically reflect at least some light, although embodiments may also absorb light.

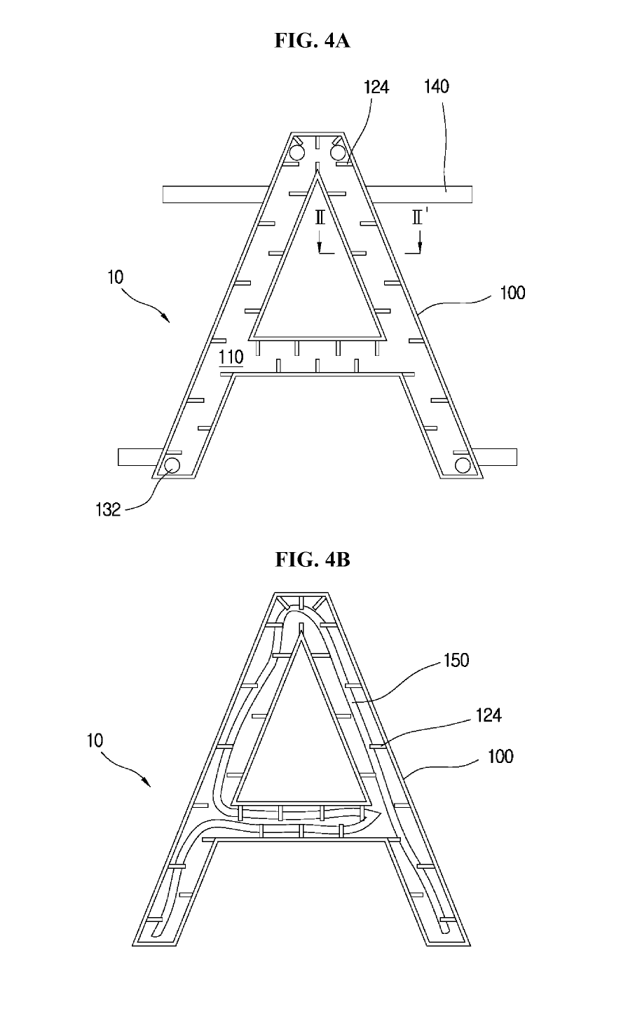

FIGS. 4A and 4B are plan views of an ornamental character according to another exemplary embodiment, and FIG. 5 is a cross section of an ornamental character according to another exemplary embodiment.

As with the embodiment of FIG. 1, the character 10 of FIGS. 4A and 4B include side walls 100 forming channels 110, and include straps 140. However, straps 140 are not illustrated with buckles. Indeed, straps 140 may use various other means for connecting to each other or other support surfaces, including but not limited to snaps, hook-and-eye fasteners, button-and-hole fasteners, hook-and-loop fasteners, and adhesives.

In the embodiments of FIGS. 4A, 4B, and 5, the light string 150 is retained within the channels 110 via tabs 124 that extend inwardly from the upper sides of walls 100 to partially extend across the channels 110. Because the inward-extending tabs 124 do not extend all the way across the channels 110, a light string 150 may be inserted into the channel 110. Once there, the light string 150 will typically droop under gravity towards the side walls 100, where the inward-extending tabs 124 can thus prevent further movement.

Rather than being located in the side walls like the openings 130 in the embodiment of FIG. 1, the openings 132 in the embodiment of FIG. 4A are located in the back or rear wall of channel 110. The character 10, as illustrated, includes four (4) openings 132 in the form of a pair in the bottom rear walls and a pair in the upper rear walls of the channels 110, but embodiments are not limited thereto.

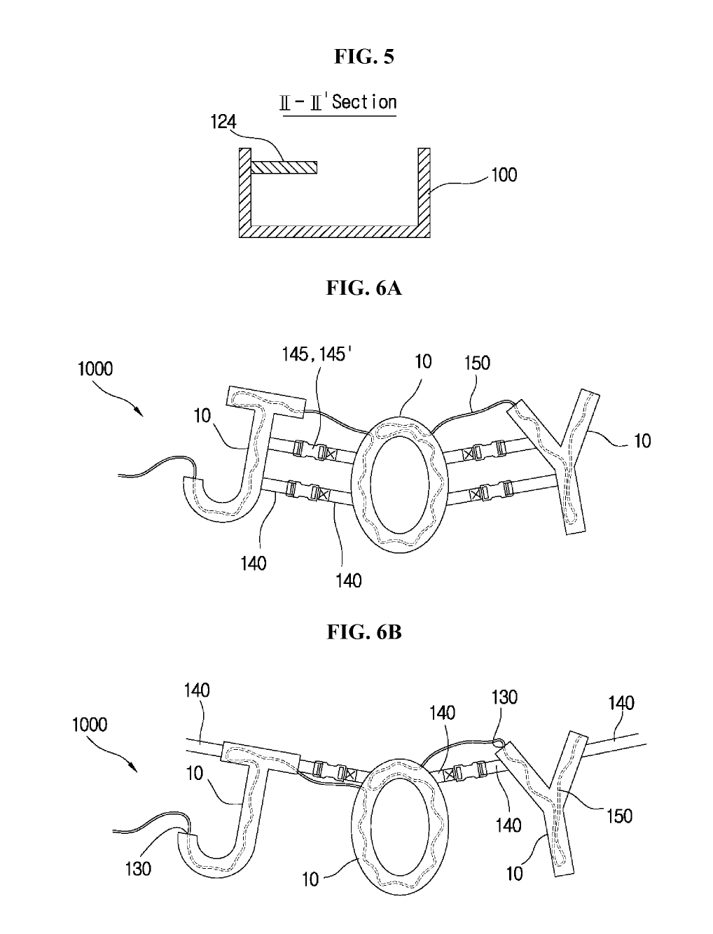

FIGS. 6A and 6B are plan views of ornamental signs according to exemplary embodiments.

FIG. 6A illustrates an ornamental sign 1000. The sign 1000 includes multiple characters 10 that are connected via multiple (i.e., upper and lower) connection members including straps 140 and complementary buckles 145, 145′ between adjacent characters 10, which in this case form a sign spelling “JOY.” A light string 150 enters at a lower first side of the “J” character, extends through the “J” channels, and exits at an upper second side of the “J.” The light string 150 then enters at an upper first side of the “O” character, extends through the “O” channels, and exits at an upper second side of the “O.” The light string 150 then enters at an upper first side of the “Y” character, extends through the “Y” channels, and exits or terminates at an upper second side of the “Y.”

FIG. 6B also illustrates an ornamental sign 1000. The sign 1000 includes multiple characters 10 that are connected via single connection members including straps 140 between adjacent characters 10, which in this case form a sign spelling “JOY.” The straps 140 further extend from the characters 10 at either end of the sign 1000 to attach to an external support (not shown) in order to support the sign 1000. In this case, the straps 140 between adjacent characters 10 may be fastened to each other with snaps, hook-and-eye fasteners, button-and-hole fasteners, hook-and-loop fasteners, or adhesives. As with FIG. 6A, FIG. 6B discloses a light string 150 that enters at a lower first side of the “J” character, extends through the “J” channels, and exits at an upper second side of the “J.” The light string 150 then enters at an upper first side of the “O” character, extends through the “O” channels, and exits at an upper second side of the “O.” The light string 150 then enters at an upper first side of the “Y” character, extends through the “Y” channels, and exits or terminates at an upper second side of the “Y.”

Although various exemplary embodiments are described with respect to ornamental signage and characters for use with light strings, it is contemplated that various exemplary embodiments are also applicable to functional signage, such as, for example, advertising signs.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. An ornamental character, comprising:
a channel comprising at least one wall defining an open end configured to form a character shape;
an opening in the at least one wall dimensioned for passage of a light string; and
retention elements disposed adjacent the open end of the channel and configured to intermittently block the open end of the channel along a length thereof to allow retention of the light string.

2. The ornamental character of claim 1, wherein the channel comprises a cross section selected from the group consisting of a semi-circle, a parabola, a semi-oval, a V-shape, a U-shape, an open-ended rectangle, an open-ended trapezoid, an open-ended polygon comprising 4 or more walls, and combinations thereof.

3. The ornamental character of claim 1, wherein the character shape is selected from the group consisting of a letter, a number, a punctuation mark, a heart, a spade, a diamond, a club, a star, a musical note, a musical-instrument shape, an arrow, a mathematical symbol, a currency symbol, a leaf, a flower, a bow, a candle, an emoticon, and a religious symbol.

4. The ornamental character of claim 1, wherein the channel comprises a transparent or translucent material.

5. The ornamental character of claim 1, wherein the channel comprises a reflective or light-diffusing material.

6. The ornamental character of claim 1, further comprising a connection member extending from the at least one wall.

7. The ornamental character of claim 1, wherein the opening comprises a through-hole or an open-ended slot.

8. The ornamental character of claim 1, wherein the retention elements comprise one of straps, transparent straps, and translucent straps.

9. The ornamental character of claim 1, wherein the retention elements comprise tabs extending inward from a wall forming the open end.

10. The ornamental character of claim 1, further comprising hooks extending inward into the channel from the at least one wall.

11. The ornamental character of claim 1, further comprising the light string at least partially disposed in the channel and comprising at least one portion passing through the opening, wherein the retention elements are configured to retain the light string within the channel when the channel is oriented vertically.

12. An ornamental sign, comprising:
a first character element comprising a first connection member extending therefrom; and
a second character element comprising a second connection member extending therefrom and configured to interface and connect to the first connection,
wherein each of the first character element and the second character element comprise:
a channel comprising at least one wall defining an open end configured to form a character shape;
an opening in the at least one wall dimensioned for passage of a light string; and
retention elements disposed adjacent the open end of the channel and configured to intermittently block the open end of the channel along a length thereof to allow retention of the light string.

13. The ornamental sign of claim 12, wherein the channels of the first and second character elements comprise a cross section selected from the group consisting of a semi-circle, a parabola, a semi-oval, a V-shape, a U-shape, an open-ended rectangle, an open-ended trapezoid, an open-ended polygon comprising 4 or more walls, and combinations thereof.

14. The ornamental sign of claim 12, wherein the first and second character element shapes are selected from the group consisting of a letter, a number, a punctuation mark, a heart, a spade, a diamond, a club, a star, a musical note, a musical-instrument shape, an arrow, a mathematical symbol, a currency symbol, a leaf, a flower, a bow, a candle, an emoticon, and a religious symbol.

15. The ornamental sign of claim 12, wherein the openings in the first and second character elements comprise one of a through-hole and an open-ended slot.

16. The ornamental sign of claim 12, wherein:
the first connection member comprises a strap having a first side of a fastener, and
the second connection member comprises a strap having a second complementary side of the fastener.

17. The ornamental sign of claim 16, wherein the fastener is selected from the group of buckles, snaps, hook-and-eye fasteners, button-and-hole fasteners, hook-and-loop fasteners, and adhesives.

18. The ornamental sign of claim 16, wherein the strap of at least one of the first connection member and the second connection member is adjustable in length.

19. The ornamental sign of claim 12, wherein the openings of the character elements comprise one of a through-hole and an open-ended slot.

20. The ornamental sign of claim 12, wherein the retention elements of the character elements are selected from the group consisting of straps, transparent straps, translucent straps, and inward-extending tabs.

21. The ornamental sign of claim 12, further comprising the light string at least partially disposed in the channel of the first character element and comprising at least a first portion passing through the opening in the first character element, and at least partially disposed in the channel of the second character element and comprising at least a second portion passing through the opening in the second character element, wherein the retention elements are configured to retain the light string within the channels when the channels of the first and second character elements are oriented vertically.

22. The ornamental sign of claim 12, wherein the channels of the character elements comprise a transparent or translucent material.

23. The ornamental sign of claim 12, wherein the channels of the character elements comprise a reflective or light-diffusing material.
